(19) United States
(12) Patent Application Publication
(10) Pub. No.: US 2024/0383329 A1
(43) Pub. Date: Nov. 21, 2024

(54) FASTENING STRUCTURE OF UNDERCOVER

(71) Applicant: TOYOTA JIDOSHA KABUSHIKI KAISHA, Toyota-shi (JP)

(72) Inventors: Masato SEKISHIRO, Nagakute-shi (JP); Ryoji DOI, Nagakute-shi (JP)

(73) Assignee: TOYOTA JIDOSHA KABUSHIKI KAISHA, Toyota-shi (JP)

(21) Appl. No.: 18/437,675

(22) Filed: Feb. 9, 2024

(30) Foreign Application Priority Data
May 19, 2023 (JP) 2023-083385

(51) Int. Cl. B60K 15/067; B60K 1/04; B60K 15/063

(52) U.S. Cl. CPC B60K 15/067; B60K 1/04; B60K 2015/0634

(57) ABSTRACT

A fastening structure of an undercover includes a fuel tank disposed under a floor of a vehicle, a first undercover covering the fuel tank from below, and a coupling bracket for mechanically coupling the first undercover to a fixing member, the coupling bracket being fastened to an upper surface of the first undercover and being fastened to the fixing member on both sides in a front-rear direction with the fuel tank interposed between the fixing members.

### CROSS-REFERENCE TO RELATED APPLICATION

This application claims priority to Japanese Patent Application No. 2023-083385 filed on May 19, 2023, incorporated herein by reference in its entirety.

### BACKGROUND

### 1. Technical Field

The present specification discloses a fastening structure of an undercover disposed under a floor of a vehicle.

### 2. Description of Related Art

Conventionally, it has been proposed to dispose a fuel tank under the floor of the vehicle. In this case, aerodynamic performance may deteriorate due to an unevenness generated on a lower surface of the vehicle due to the fuel tank. Therefore, it has been proposed in some cases to provide the undercover that covers the fuel tank from below. For example, Japanese Unexamined Patent Application Publication No. 2021-187232 (JP 2021-187232 A) discloses a vehicle in which the fuel tank and a main battery are covered with the undercover.

### SUMMARY

Here, when such an undercover is directly fastened to a bottom surface of a fuel tank, sufficient aerodynamic performance cannot be obtained. That is, internal pressure of the fuel tank greatly changes depending on a traveling condition, and the entire tank may expand and contract. When the undercover is directly fastened to the fuel tank, a fastening portion of the undercover with the fuel tank is displaced up and down as the fuel tank expands and contracts. As a result, in this case, unevenness or a step generates in the undercover, and high aerodynamic performance cannot be maintained.

Therefore, in the present specification, a fastening structure of an undercover capable of further improving aerodynamic performance of a vehicle is disclosed.

A fastening structure of an undercover disclosed in the present specification includes a fuel tank disposed under a floor of a vehicle, a first undercover covering the fuel tank from below, and a coupling bracket for mechanically coupling the first undercover to a fixing member, the coupling bracket being fastened to an upper surface of the first undercover and being fastened to the fixing member on both sides in a front-rear direction with the fuel tank interposed between the fixing members.

With this configuration, since the first undercover is not affected by expansion and contraction of the fuel tank, deformation of the first undercover can be effectively prevented. As a result, the aerodynamic performance of the vehicle can be further improved.

In this case, the fastening structure may further include a main battery disposed adjacent to the fuel tank in a vehicle front-rear direction, and a second undercover covering the main battery from below. The first undercover and the second undercover may be separate members disposed in a same plane with each other or a single member integrally connected to each other.

By covering both the fuel tank and the main battery with the undercover disposed in the same plane, the aerodynamic performance of the vehicle can be further improved.

Further, the fixing member may include a vehicle frame member and a support frame supporting a housing of a main battery or the main battery, and the coupling bracket may include a first fastening portion fastened to the housing or the support frame, and a second fastening portion located on an opposite side of the fuel tank from the first fastening portion and fastened to the vehicle frame member.

With this configuration, the coupling bracket can be appropriately fastened to the fixing member.

Also, the coupling bracket may include a cover fastening portion fastened to the first undercover, and at least one of the first fastening portion and the second fastening portion may be located on a vehicle upper side from the cover fastening portion.

With this configuration, the deformation of the first undercover in association with a front collision or a rear collision is likely to be deformation that is projecting toward the vehicle lower side rather than deformation that is projecting toward the vehicle upper side. Therefore, interference between the first undercover and the fuel tank, and thus, damage to the fuel tank can be effectively prevented.

Also, the coupling bracket may include the cover fastening portion fastened to the first undercover by a fastening member, the fastening member may include a head portion and a shaft portion protruding from the head portion and the head portion may be assembled to the coupling bracket in a posture in which the head portion is on the vehicle upper side from the shaft portion, and the cover fastening portion may be locally recessed compared to a periphery.

With this configuration, even when the coupling bracket receives an upward load, interference between the shaft portion of the fastening member and the fuel tank can be effectively prevented. As a result, damage to the fuel tank can be effectively prevented.

According to the fastening structure of the undercover disclosed in the present specification, the aerodynamic performance of the vehicle can be further improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a vehicle viewed from below;

FIG. 2 is an A-A sectional view of FIG. 1; and

FIG. 3 is an enlarged view of a portion B of FIG. 2.

### DETAILED DESCRIPTION OF EMBODIMENTS

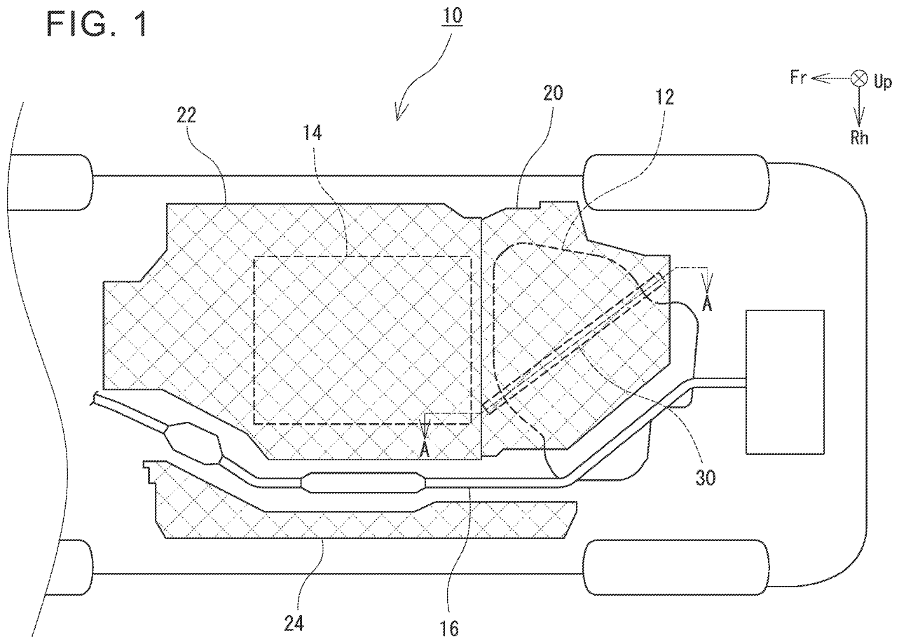

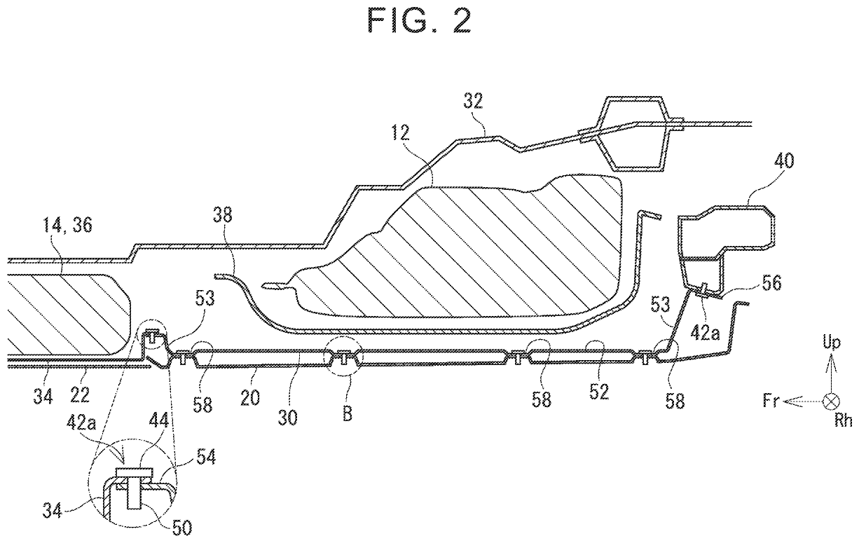

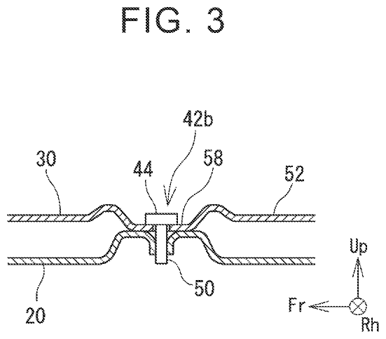

Hereinafter, a mounting structure of an undercover will be described with reference to the drawings. FIG. 1 is a schematic view of a vehicle 10 viewed from below. Also, FIG. 2 is a A-A sectional view of FIG. 1. Further, FIG. 3 is an enlarged view of a portion B of FIG. 2. Note that, in the drawings, “Fr”, “Up”, and “Rh” indicate a vehicle front side, a vehicle upper side, and a vehicle right side, respectively.

The vehicle 10 shown in FIG. 1 is a hybrid battery electric vehicle equipped with both an engine and a motor (both not shown) as a power source of the vehicle 10. In an example of FIG. 1, both the engine and the motor are disposed in a front portion of the vehicle 10.

A main battery 14, a fuel tank 12, and an exhaust pipe 16 are disposed under a floor of the vehicle 10, that is, below a floor panel 32. The main battery 14 stores electric power to be supplied to the motor. The main battery 14 is a secondary battery that can be discharged and charged. The main battery 14 is in a flat shape with a smaller thickness than an outer shape size. Such a main battery 14 is disposed as downward as possible in order to secure a wide interior space. Also, the main battery 14 is disposed approximately in the center of the vehicle 10. Further, a housing 36 of the main battery 14 is assembled to a battery support frame 34, and the battery support frame 34 is fixed to the vehicle 10.

The fuel tank 12 is a tank that stores fuel to be supplied to the engine. The fuel tank 12 is disposed adjacent to and on the vehicle rear side of the main battery 14. As shown in FIG. 2, a vertical dimension of the fuel tank 12 is significantly larger than a vertical dimension of the main battery 14. The fuel tank 12 is assembled to a tank support frame 38, and the tank support frame 38 is fixed to the vehicle 10.

The exhaust pipe 16 is a pipe that guides exhaust gas discharged from the engine to a main muffler. As shown in FIG. 1, the exhaust pipe 16 passes through a side of the main battery 14 in a process from the engine toward the main muffler. The exhaust pipe 16 becomes extremely hot during operation of the engine.

Here, components disposed under the floor of the vehicle 10 are covered by undercovers 20, 22, 24 from below. In FIG. 1, a first undercover 20 covering the fuel tank 12, a second undercover 22 covering the main battery 14, and a side undercover 24 disposed on a right side of the exhaust pipe 16 are illustrated.

Each of the undercovers 20, 22, 24 is a panel member made of resin, and the bottom surfaces thereof are approximately flat. In FIG. 1, the undercovers 20, 22, 24 are hatched. Such undercovers 20, 22, 24 are provided to improve aerodynamic performance, and thus, to improve fuel efficiency and electricity consumption, and to reduce carbon emission.

That is, when the undercovers 20, 22, 24 are not provided, the bottom surface of the vehicle 10 is constructed by the main battery 14 and the fuel tank 12. In this case, a large number of unevennesses exist on the bottom surface of the vehicle 10. Such unevenesses lead to air stagnation and turbulence. As a result, when the undercovers 20, 22, 24 are not provided, flow of wind between the vehicle 10 and a road surface deteriorates, and the aerodynamic performance decreases. In contrast, when the undercovers 20, 22, 24 are provided, the bottom surface of the vehicle 10 becomes approximately flat, and therefore, the air stagnation and the turbulence are less likely to occur, and the flow of the wind becomes smooth. As a result, the aerodynamic performance of the vehicle 10 improves. Note that, as described above, the undercovers 20, 22, 24 are made of resin and have a low heat resistance temperature. Therefore, the undercovers 20, 22, 24 are disposed so as to avoid the high-temperature exhaust pipe 16. Specifically, the undercovers 20, 22, 24 are divided into right and left sides with the exhaust pipe 16 interposed therebetween.

As shown in FIG. 1, the first undercover 20 and the second undercover 22 are disposed side by side in a front-rear direction. In order to improve the aerodynamic performance, the first undercover 20 and the second undercover 22 are assembled so as to be located approximately in the same plane with each other. Also, in order to prevent the first undercover 20 from being deformed even when the fuel tank 12 is deformed, a coupling bracket 30 is provided in the present example.

The coupling bracket 30 is a component made of a rigid material such as metal and is a component approximately in a flat plate shape elongated in one direction. In the present example, the coupling bracket 30 is disposed to be inclined with respect to the vehicle front-rear direction so as to extend in the vehicle width direction as it extends toward the vehicle rear direction. By disposing the coupling bracket 30 so as to be inclined as described above, it is possible to exert a proof stress against both force in the front-rear direction and force in the vehicle width direction.

The coupling bracket 30 is fastened to a fixing member of the vehicle 10, specifically, the battery support frame 34 and a rear suspension member 40. Also, the first undercover 20 is fastened to the bottom surface of the coupling bracket 30. Therefore, the first undercover 20 is coupled to the fixing member via the coupling bracket 30. In other words, in the present example, the first undercover 20 is not fastened to the bottom surface of the fuel tank 12. With this configuration, deformation of the first undercover 20 can be prevented, and high aerodynamic performance can be maintained. The reason for this will be described.

Internal pressure of the fuel tank 12 greatly changes depending on use environment, a traveling state, and the like. With the internal pressure change, the fuel tank 12 itself expands and contracts. When the first undercover 20 is fastened to the bottom surface of the fuel tank 12, the first undercover 20 deforms as the fuel tank 12 expands and contracts. Then, when the unevenness is generated in the first undercover 20 due to the deformation, accordingly, the flow of the wind becomes worse, and the aerodynamic performance deteriorates. Therefore, as shown in FIG. 2, the first undercover 20 is disposed so as to be spaced downward from the bottom surface of the fuel tank 12. Thus, even when the fuel tank 12 expands and contracts, the deformation of the first undercover 20 can be effectively prevented.

However, when the first undercover 20 is only spaced apart from the fuel tank 12, in other words, when the coupling bracket 30 is not used, there is an issue that the rigidity of the first undercover 20 is insufficient. For example, a case where a front end and a rear end of the first undercover 20 are fastened to the fixing member will be considered. In this case, a central portion of the first undercover 20 is easily bent, and sufficient rigidity cannot be maintained. Therefore, when the coupling bracket 30 is not used, the size of the first undercover 20 must be reduced in order to secure rigidity, and accordingly, the aerodynamic performance may decrease.

In contrast, in the present example, the coupling bracket 30 made of the rigid material is provided, and the first undercover 20 is fastened to the coupling bracket 30. Accordingly, sufficient rigidity can be secured even when a size of the first undercover 20 increases. As a result, since approximately the entire fuel tank 12 can be covered with the first undercover 20, the aerodynamic performance improves. Also, as shown in FIG. 2, in the present example, the coupling bracket 30 and the first undercover 20 are both spaced apart from the fuel tank 12. Therefore, even when the fuel tank 12 expands and contracts, deformation of the coupling bracket 30 and the first undercover 20 is prevented.

Next, a configuration of the coupling bracket 30 will be described in more detail. As described above, the coupling bracket 30 is the elongated flat plate shape member made of metal. A first fastening portion 54 is provided at a front end of the coupling bracket 30. The coupling bracket 30 is fastened to the battery support frame 34 by a fastening member 42a in the first fastening portion 54. The fastening member 42a is a bolt, for example, with a head portion 44 and a shaft portion 50 protruding from the head portion 44. However, the fastening member 42a is not limited to a bolt and may be another member. For example, the fastening member 42a may be a rivet, a clip, and the like.

A second fastening portion 56 is provided at a rear end of the coupling bracket 30. The coupling bracket 30 is fastened to the rear suspension member 40 by the fastening member 42a in the second fastening portion 56. Here, as is clear from FIG. 2, the second fastening portion 56 is located on the opposite side of the fuel tank 12 from the first fastening portion 54. In other words, the coupling bracket 30 is fastened to the fixing member on both sides in the front-rear direction with the fuel tank 12 interposed therebetween.

A plurality of cover fastening portions 58 is provided on a general surface 52 of the coupling bracket 30. The coupling bracket 30 is fastened to the first undercover 20 by a fastening member 42b in the cover fastening portion 58. Note that the fastening member 42b is a bolt with a head portion 44 and a shaft portion 50 protruding from the head portion 44, similarly to the fastening member 42a.

Here, as is clear from FIG. 2, the front end and the rear end of the coupling bracket 30 are raised above the general surface 52 of the coupling bracket 30, and the first fastening portion 54 and the second fastening portion 56 are provided on a rising portion 53. In other words, the first fastening portion 54 and the second fastening portion 56 are located above the general surface 52, and thus, the cover fastening portion 58 which will be described later. With this configuration, when force in the vehicle front-rear direction is input to the first fastening portion 54 or the second fastening portion 56 in association with a front collision or a rear collision, the deformation of the first undercover 20 is likely to be deformation projecting toward the vehicle lower side rather than deformation projecting toward the vehicle upper side. Thus, as a result, even in a collision, interference between the first undercover 20 and the fuel tank 12, and thus, damage to the fuel tank 12 can be effectively prevented.

Further, as shown in FIG. 3, in the cover fastening portion 58, the head portion 44 of the fastening member 42b is assembled in a posture in which the head portion 44 is located above the shaft portion 50. Also, the cover fastening portion 58 is locally recessed as compared to a periphery thereof. With this configuration, the sharp shaft portion 50 is prevented from colliding with the fuel tank 12.

That is, as the vehicle 10 travels, an obstacle on the road surface may collide with the first undercover 20 or the coupling bracket 30, and the cover fastening portion 58 may be pushed upward. As shown in FIG. 3, even when the cover fastening portion 58 is subject to upward force, rather than the cover fastening portion 58, the general surface 52 around the cover fastening portion 58 abuts on the bottom surface of the fuel tank 12 in advance, in a case where the cover fastening portion 58 is recessed than the periphery thereof. Then, this abutment effectively prevents the cover fastening portion 58, and thus, the hard fastening member 42b from colliding with the bottom surface of the fuel-tank 12. Further, in the present embodiment, the head portion 44 of the fastening member 42b is located above the shaft portion 50. Therefore, even when the periphery of the cover fastening portion 58 is raised high, the sharp shaft portion 50 does not collide with the fuel tank 12. As a result, damage to the fuel tank 12 is effectively prevented.

As is apparent from the above description, according to the fastening structure of the undercover disclosed in the present specification, since the first undercover 20 is not fastened to the fuel tank 12, the first undercover 20 does not deform even when the fuel tank 12 expands or contracts. Further, since the rigidity of the first undercover 20 is reinforced by the coupling bracket 30, the size of the first undercover 20 can be made larger. As a result, according to the fastening structure disclosed in the present specification, the aerodynamic performance of the vehicle 10 is improved, and thus, the fuel efficiency and the electricity consumption are improved, and the carbon emission is reduced.

Note that any of the configurations described above is an example, and the fastening structure may be changed as appropriate as long as the configuration described in claim 1 is provided. For example, in the above description, the first undercover 20 and the second undercover 22 are separate components separated from each other. However, the two undercovers 20, 22 may be a single member integrally connected to each other. Also, in the above description, the coupling bracket 30 is fastened to the battery support frame 34 and the rear suspension member 40. However, the coupling bracket 30 may be fastened to another member as long as the another member is a component of the vehicle and is a fixing member substantially stationary with respect to the fuel tank 12. For example, the coupling bracket 30 may be fastened to the housing 36 of the main battery 14, in the first fastening portion 54. Further, the coupling bracket 30 may be fastened to another vehicle frame member such as a cross member, in the second fastening portion 56. Further, a posture of the fastening members 42a, 42b, a shape of the periphery of the cover fastening portion 58, and the like may be changed as appropriate.

What is claimed is:

1. A fastening structure of an undercover, the fastening structure comprising:
a fuel tank disposed under a floor of a vehicle;
a first undercover covering the fuel tank from below; and
a coupling bracket for mechanically coupling the first undercover to a fixing member, the coupling bracket being fastened to an upper surface of the first undercover and being fastened to the fixing member on both sides in a front-rear direction with the fuel tank interposed between the fixing members.

2. The fastening structure according to claim 1, further comprising:
a main battery disposed adjacent to the fuel tank in a vehicle front-rear direction; and
a second undercover covering the main battery from below, wherein the first undercover and the second undercover are separate members disposed in a same plane with each other or a single member integrally connected to each other.

3. The fastening structure according to claim 1, wherein:
the fixing member includes a vehicle frame member and a support frame supporting a housing of a main battery or the main battery; and
the coupling bracket includes a first fastening portion fastened to the housing or the support frame, and a second fastening portion located on an opposite side of the fuel tank from the first fastening portion and fastened to the vehicle frame member.

4. The fastening structure according to claim 3, wherein:
the coupling bracket includes a cover fastening portion fastened to the first undercover; and
at least one of the first fastening portion and the second fastening portion is located on a vehicle upper side from the cover fastening portion.

5. The fastening structure according to claim 1, wherein:
the coupling bracket includes a cover fastening portion fastened to the first undercover by a fastening member,
the fastening member includes a head portion and a shaft portion protruding from the head portion and the head portion is assembled to the coupling bracket in a posture in which the head portion is on a vehicle upper side from the shaft portion; and
the cover fastening portion is locally recessed compared to a periphery.
